(19) United States
(12) Patent Application Publication
(10) Pub. No.: US 2015/0102234 A1
(43) Pub. Date: Apr. 16, 2015

(54) SYSTEMS AND METHOD FOR FLUORESCENCE IMAGING

(71) Applicant: LIFE TECHNOLOGIES CORPORATION, Carlsbad, CA (US)

(72) Inventors: Ari Gargir, Rishpon (IL); Jason Alfred Dallwig, Eugene, OR (US); Matthew Paul Beaudet, Eugene, OR (US)

(21) Appl. No.: 14/399,905

(22) PCT Filed: May 9, 2013
(86) PCT No.: PCT/US2013/040424

§ 371 Date: Nov. 7, 2014

Related U.S. Application Data
(60) Provisional application No. 61/644,968, filed on May 9, 2012.

(51) Int. Cl. G01N 21/64

(52) U.S. Cl. CPC G01N 21/6456; G01N 21/6486; G01N 2201/062; G01N 2201/068
USPC 250/459.1; 250/458.1; 250/208.1

(57) ABSTRACT

An apparatus for producing an image of blotting membranes includes an enclosure, light source, optical system, photodetector, and beamsplitter. The enclosure supports a blotting substrate comprising a first probe characterized by an excitation wavelength and an emission wavelength and a second probe characterized by an excitation wavelength and an emission wavelength. The light source directs diverging light to illuminate an entirety of the active area. The optical system forms an image of the entire active area and comprises an optical filter, the optical filter having an optical characteristic highly transmissive of light at the emission wavelengths and highly reflective of light at the excitation wavelengths. The beamsplitter may comprise an optical characteristic that is highly transmissive of light at the first and second emission wavelengths and that is highly reflective of light at the first and second excitation wavelengths.

### RELATED APPLICATION

The present application claims priority under 35 U.S.C §119(e) to provisional application No. 61/644,968, filed on May 9, 2012, the entire contents of which are hereby incorporated by reference in its entirety for all purposes as if fully set forth herein.

### BACKGROUND OF THE INVENTION

1. Field of the Invention

The present invention relates generally to optical systems and methods for biological samples, and more specifically to optical systems and methods for fluorescence imaging of two-dimensional distributions of biomolecular samples.

2. Description of the Related Art

Fluorescence readers and imaging devices are used in the identification of various biomolecular substances such as protein, DNA, or RNA molecules. Samples containing such molecules may be prepared according to various known procedures, protocols, or assays. Molecules within the samples may be detected, analyzed, and/or differentiated using various light-absorptive, radioactive, luminescent, or fluorescent compounds known in the art. For example, one or more fluorophores, such as fluorescent probe, dyes, markers, may be added to the sample to produce fluorescent signals or images indicative of the presence or amount of one or more target molecules.

Procedures for detecting or imaging may include attachment of reporter moieties to separated species. Examples of such procedures include the use of blotting membranes. Depending of the type of biomolecule of interest “Southern,” “Northern,” and “Western” blotting procedures may be used. For example, a Western blot is typically used in detecting or measuring protein molecules.

Typical instruments are expensive and complex. Systems and methods are needed that allow experimental results with minimal training. Additionally, low cost systems are needed to allow proliferation of these techniques to bench-top users. Quantum dot systems are attractive, but currently suffer from lack of a dedicated, low-cost device for Western blot detection and cellular analysis. Thus, simple and inexpensive Western blot systems and methods are also needed.

### BRIEF DESCRIPTION OF THE DRAWINGS

Aspects, features, and advantages of the present invention are set forth in the following description and claims, particularly when considered in conjunction with the accompanying drawings in which like parts bear like reference numbers. Embodiments of the present invention may be better understood from the following detailed description when read in conjunction with the accompanying drawings. Such embodiments, which are for illustrative purposes only, depict novel and non-obvious aspects of the invention. The drawings include the following figures:

FIG. 1 is a schematic diagram of a system according to an embodiment of the present invention.

FIG. 2 is a table of various embodiments of systems like that shown in FIG. 1.

FIG. 3 is photograph of a system according to an embodiment of the present invention.

FIG. 4 is test results obtained using the system shown in FIG. 3

### DETAILED DESCRIPTION OF THE DRAWINGS

Embodiments of the present invention are generally directed to systems and methods for obtaining fluorescent data from samples containing one or more fluorescent dyes, markers, or probes. Such embodiments may incorporate imaging systems or instruments to record fluorescent images of substrate including protein, DNA, and/or RNA molecules, or the like. In certain embodiments, the systems and methods involve a sample substrate suitable for use blot methods for detecting and measuring proteins, DNA, and/or RNA. Examples include, but are not limited to Western blot, Southern blot, Northern blot, Eastern blot, Southwestern blot, reverse Northern blot, Far-Western or Far-Eastern blot, Dot blot, Slot blot, or the like.

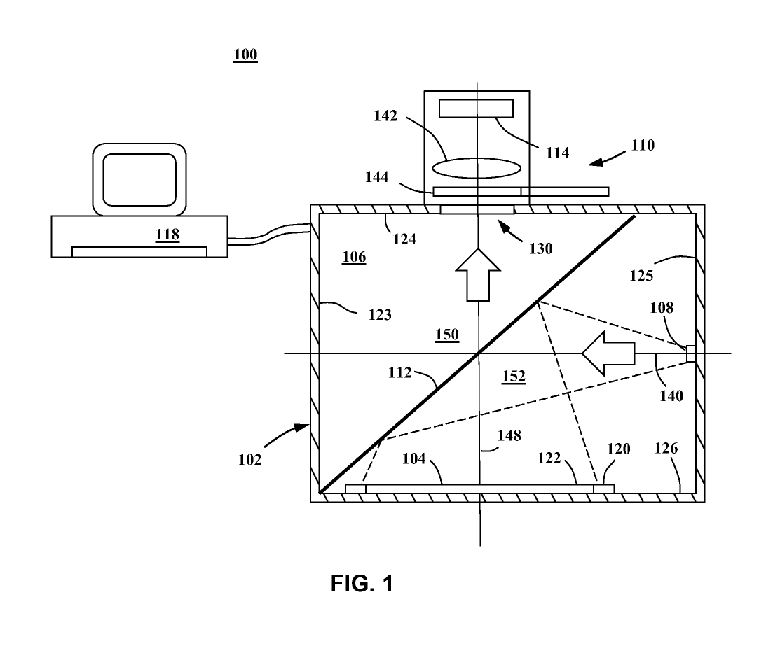

Referring to FIG. 1, in certain embodiments an instrument, apparatus, or system 100 comprises a housing 102 and is configured to produce an image of a two-dimensional distribution of one or more biomolecular samples 104 located inside a compartment, chamber, cavity, or enclosure 106. System 100 also comprises an excitation source or light source 108, an optical system 110, and a beamsplitter 112 that together are configured to produce an image of samples 104, the image being received by a photosensor or photodetector 114 to produce an electronic signal. System 100 may further comprise a controller, processor, computational system, or computer 118 that is configured to operate system 100 and/or to collect or record data from samples 104.

Computer 118 may include electronic memory storage containing instructions, routines, algorithms, test and/or configuration parameter, test or experimental data, or the like. Computer 118 may be configured, for example, to operate various components of the optical system or to obtain and/or process data provided by system 100. For example, computer 118 may be used to obtain and/or process optical data provided by photodetector 114. In certain embodiments, computer 118 may communicate with additional external computer and/or transmit data to an external computer for further processing, for example, using a hardwire connection, a local area network, an internet connection, cloud computing system, or the like. Computer 118 may be physical computer, such as a desktop computer, laptop computer, notepad computer, tablet computer, or the like. Additionally or alternatively, computer 118 may comprise a virtual device or system such as a cloud computing or storage system. Data may be transferred or shared between computers 118 and an external computer via a wireless connection within a local area network, a cloud storage or computing system, or the like. Additionally or alternatively, data from system 100 may be transferred to an external memory storage device, for example, an external hard drive, a USB memory module, a cloud storage system, or the like.

Enclosure 106 may be configured to support or hold samples 104, for example, by providing a floor, base, stage, pedestal, or the like within enclosure 106. Samples 104 may also be contained on or within a sample holder 120 that include an active area 122 and that is supported or held within enclosure 106. As used herein, the term “active area” refers to a portion or area of a sample holder containing one or more samples for which images and/or information is to be obtained. Sample holder 120 may comprise a substrate, gel, membrane, or other structure or material suitable for holding or maintaining samples 104.

In certain embodiments, one or more of the samples 104 include fluorophore, such a fluorescent probe, fluorescent dye, fluorescent marker, or the like. For example, one or more of the samples 104 may comprise a first fluorescent probe characterized by a first excitation wavelength (or wavelength band) and a first emission wavelength (or wavelength band) and a second fluorescent probe characterized by a second excitation wavelength (or wavelength band) and a second emission wavelength (or wavelength band). In certain embodiments, any or all of the characteristic wavelengths may be an average or median wavelength of a wavelength band, or a wavelength at which the value is the maximum over a wavelength band. Each fluorescent probe may be configured to be activated or provide increased fluorescence when bound to a predetermined chemical sequence corresponding to each fluorescent probe is present within samples 104. The predetermined chemical sequences may include one more of a polynucleotide, an amino acid sequence, a DNA sequence, an RNA sequence, or the like. The sample may further comprise additional fluorescent probes, or the like, where each fluorescent probe may be configured to be activated or provide increased fluorescence when bound to a predetermined chemical sequence corresponding to each fluorescent probe is present within samples 104. The predetermined chemical sequences may include only one type of sequence (e.g., comprise only amino acid sequences, only DNA sequences, or only RNA sequences) or may include a combination of different types of sequences (e.g., one or more amino acid sequences and one or more DNA and/or RNA sequences). In certain embodiments, one or more of the samples 104 include one or more types of nanocrystal probe materials or quantum dot probe materials. These materials may be used as an alternative to, or in addition to, the fluorescent probes discussed in the paragraphs above. Advantageously, such material may be used to increase the flexibility and/or signal strength when used in the various applications discussed above in relation to more traditional fluorophores.

In certain embodiments, sample holder 120 comprises a blotting membrane or substrate, or similar structure, for use in a blotting assay that includes a fluorophore, nanocrystal, quantum dot, and/or other fluorescent dye or probe. In such embodiments, samples 104 may include one or more target peptide or proteins sequences and active area 122 may comprise a protein immunoblot, Western blot, or dot blot. Additionally or alternatively, samples 104 may include one or more target DNA and/or RNA sequences and/or active area 122 may comprise a Southern blot, a Northern blot, an Eastern blot, or the like.

As shown in the illustrated embodiment of FIG. 1, enclosure 106 comprises a first inner wall 123, a second inner wall 124, a third inner wall 125, and a fourth inner wall 126. First inner wall 123 and third inner wall 125 are side walls disposed on opposite sides of enclosure 106. Second inner wall 124 is a top wall and includes an aperture 130 above active area 122 that provides optical communication between active area 122 and the photodetector 114. Fourth inner wall 126 is disposed at the bottom of enclosure 106 and below the sample holder 120. Light source may be disposed on third inner wall 125, as shown in FIG. 1. In such embodiments, third inner wall 125 may be located further from beamsplitter 112 than first wall 123. In addition, third inner wall 125 is further from beamsplitter 112 than second wall 124 for the illustrated embodiment. Advantageously, this location of third inner wall 125 allows the diverging beam of light source 108 to fill the entirety of active area 122 due to its greater distance from beamsplitter 112. Additionally or alternatively, third wall 125 may contain a window or aperture so that light source 108 may be mounted outside the housing 102.

Light source 108 comprises electromagnetic radiation in a wavelength band suitable of exciting fluorescent dyes or probes contained in samples 104. As used herein, the term “light source” means any source of electromagnetic radiation in the visible waveband, the UV waveband, the near infrared waveband, and/or the infrared waveband. Examples of light sources include, but are not limited to, light emitting diodes (LEDs), lasers, Xenon lamps, halogen lamps, mercury lamps, UV lamps, and/or incandescent lamps. As shown in the illustrated embodiment of FIG. 1, light source 108 may be configured to direct a diverging light beam along a first optical axis 140 so as to illuminate an entirety of active area 122. Light source 108 may comprise a wavelength spectrum that includes the first excitation wavelength and the second excitation wavelength, as well as excitation wavelengths of any additional fluorophore corresponding to additional optional target sequence contained in samples 104. Advantageously, system 100 is configured so that the entire active area 122 is illuminated and imaged simultaneously by photodetector 114. In certain embodiments, light source 108 comprises a plurality of individual light sources, for example, an array of LED light sources where at least some of the LED's are different colors or have different emitting wavelength bands.

Photodetector 114 may comprise a two dimensional segmented or pixilated detector array. For example, photodetector 114 may comprise a two-dimensional charge coupled device (CCD) detector or a two-dimensional complementary metal-oxide-semiconductor (CMOS) detector. Photodetector 114 is configured to receive one or more images produced by one or more fluorescent dyes or probes contained in samples 104.

In addition to beamsplitter 112, optical system 110 may further comprises one or more lenses 142 configured to image active area 122 onto photodetector 114 and at least one emission optical filter 144 that may be configured to filter excitation light from light source 108. The elements of optical system 110 that are located between samples 104 and photodetector 114 are disposed along a second optical axis 148, which is perpendicular to first optical axis 140 in the illustrated embodiment.

Optical filter 144 may comprise an optical characteristic that is highly transmissive of light at the emission wavelength of one or more of the fluorescent dyes or probes contained in samples 104. For example, optical filter 144 may have a transmittance that is at least 90 percent, at least 99 percent, or at least 99.9 percent over the emission wavelengths produced by one more of the fluorescent dyes or probes contained in samples 104. The optical characteristic of optical filter 144 may simultaneously be highly reflective and/or highly absorptive of light at other wavelengths (e.g., highly reflective or absorptive at all or most of the wavelength emitted by light source 108). For example, optical filter 144 may have a reflectance or absorptivity that is at least 90 percent, at least 95 percent, at least 99 percent, or at least 99.9 percent of light outside the emission wavelength of one more of the fluorescent dyes or probes contained in samples 104. Optical filter 144 may have an optical characteristic that is highly transmissive of the emission wavelengths of two or more of the fluorescent dyes or probes contained in samples 104. For example, optical filter 144 may have a transmittance that is at least 90 percent, at least 95 percent, at least 99 percent, or at least 99.9 percent over the emission wavelengths produced by two or more of the fluorescent dyes or probes contained in samples 104. Alternatively, optical filter 144 may have an optical characteristic that is highly transmissive of the emission wavelength only one of the fluorescent dyes or probes contained in samples 104. In such embodiments, the optical system may comprise a plurality of emission optical filters 144 that may be moved into and out of the optical path of emission light from samples 104. In such embodiments, a sequence of images of the samples 104 may be recorded using photodetector 114, where different images record different ones of the fluorescent dyes or probes contained in samples 104 or different sets of the fluorescent dyes or probes contained in samples 104.

In the illustrated embodiment shown in FIG. 1, beamsplitter 112 comprises an optical characteristic that is highly transmissive of light at the emission wavelengths of the fluorescent dyes or probes contained in samples 104. For example, beamsplitter 112 may have a transmittance that is at least 90 percent, at least 99 percent, or at least 99.9 percent over the emission wavelengths produced by one more of the fluorescent dyes or probes contained in samples 104. In addition, the optical characteristic of beamsplitter 112 may be highly reflective of light at wavelengths corresponding to the wavelength band or profile of light source 108 and/or highly reflective of light at wavelengths suitable for excitation of fluorescent dyes or probes contained in sample 104. For example, beamsplitter 112 may have a reflectance that is at least 90 percent, at least 99 percent, or at least 99.9 percent over the emission wavelengths produced by one more of the fluorescent dyes or probes contained in samples 104. To achieve such optical characteristics, beamsplitter 112 may be a dichroic beamsplitter or mirror. In certain embodiments, the combination of emission optical filter(s) 144 and beamsplitter 112 is advantageously very effective in reducing noise from non-fluorescent light in sample images recorded using photodetector 114, since such non-fluorescent light is twice filtered—once by beamsplitter 112 and again by emission filter(s) 144. In certain embodiments, noise from non-fluorescent light may be further reduced by using beamsplitter 112 to partition enclosure 106 into two isolated chambers or enclosed volumes 150 and 152, such that little or no light at wavelengths reflected by beamsplitter enters enclosed volume 150.

In certain embodiment, light source 108 and samples 104 directly face one another and are located on opposite sides of beamsplitter 112. In such embodiments, samples 104 are configured so that fluorescent light from samples 104 are reflected off beamsplitter 112 and to detector 114. It will be appreciated that in such embodiments, beamsplitter 112 may comprise an optical characteristic that is highly reflective of light at the emission wavelengths of the fluorescent dyes or probes contained in samples 104. In addition, the optical characteristic of beamsplitter 112 in this case may be highly transmissive of light at wavelengths corresponding to the wavelength band or profile of light source 108 and/or highly transmissive of light at wavelengths suitable for excitation of fluorescent dyes or probes contained in sample 104.

In certain embodiments, light source 108 is a single color source (e.g., a single color LED or laser) and/or has a relatively narrow wavelength band (e.g., has a bandwidth that is less than or equal to 100 nanometers, less than or equal to 50 nanometers, or less than or equal to 10 nanometers). In such embodiments, samples 104 may include two or more types of quantum dot dyes or probe that have the same or nearly the same excitation wavelength. For example, samples 104 may each comprise a first quantum dot with an excitation wavelength of 390 nanometers and an emission wavelength of 625 nanometer, and a second quantum dot with an excitation wavelength also of 390 nanometers, but an emission wavelength of 800 nanometer. A single excitation filter 144 may be used to pass emission light from both quantum dots, for example, having a transmittance that is greater than 95 percent over a wavelength band from 600 nanometers to 850 nanometers and having a transmittance of less than 1 percent at a wavelength of 390 nanometers (e.g., having a transmittance of less than 1 percent at wavelengths less than 600 nanometers). In such embodiments, beamsplitter 112 may have a high reflectivity at wavelengths equal to the excitation wavelength of the quantum dots (e.g., having a reflectivity of at least 95 percent or at least 99 percent over a wavelength range of 360 nanometers to 420 nanometers, or having a reflectivity of at least 95 percent or at least 99 percent at wavelengths less than 600 nanometers) and highly transmissive of light at the emission wavelengths of the quantum dots (e.g., highly transmissive at wavelengths greater than or equal to 600 nanometers).

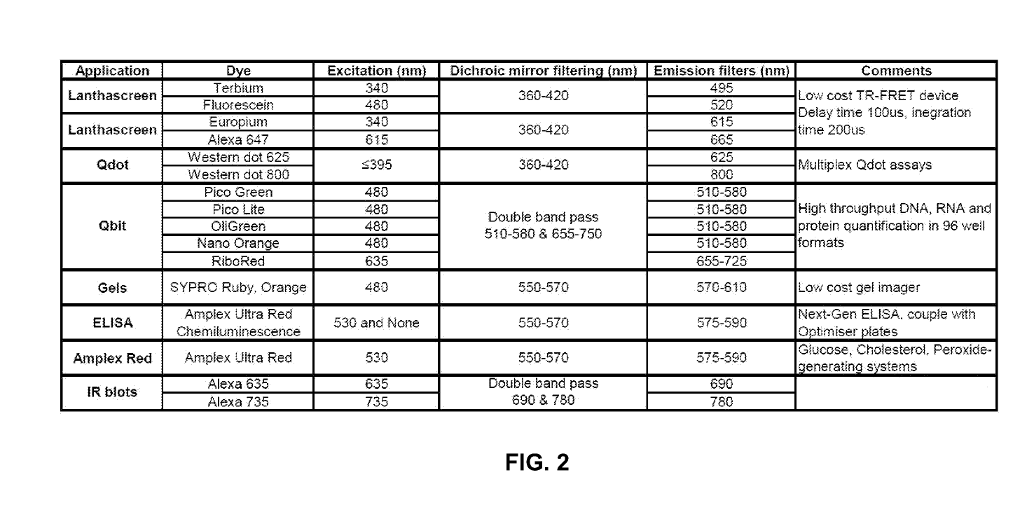

Referring to FIG. 2, a summary of various type of configurations of system 100 is presented. For example, an embodiment of the configuration describe in the previous paragraph is shown in the rows under the Applicant labeled “Qdot”.

### Examples

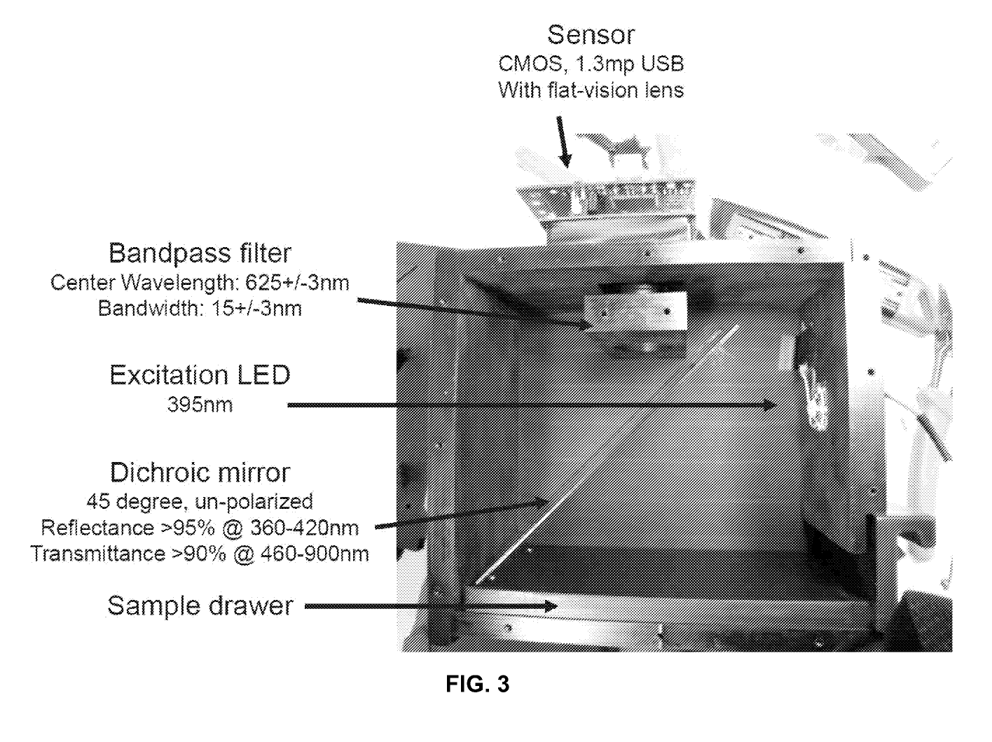

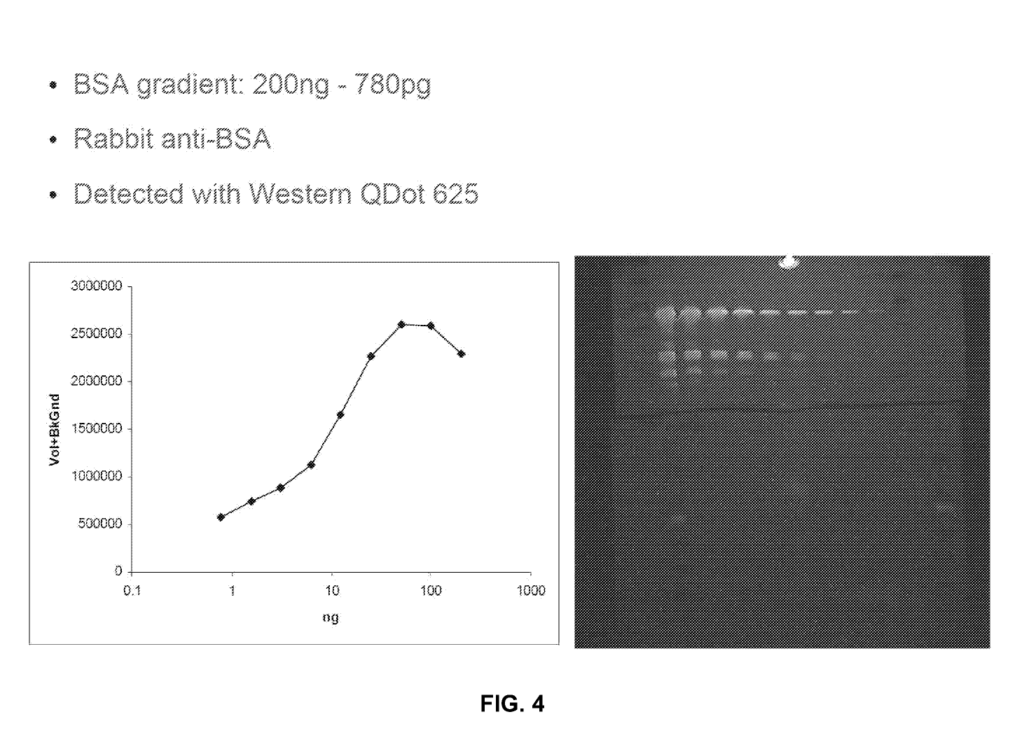

Referring to FIG. 3, an embodiment of system 100 is shown, where the system comprises a 1.3 mega pixel CMOS detector and image capturing circuit (Micron), which were mounted with a short focal length flat-vision lens (Myutron) in a blackened box. TIF format images were captured using a PC via USB cable. Two variations of the device were constructed with 2 excitation and emission sets with appropriate LED arrays at the excitation wavelengths; dichroic mirrors with application specific transmission and reflection band-pass filters for Qdot western blot imaging (FIGS. 3 and 4) and for DNA quantification.

For Qdot detection, 395 nanometers emitting LEDs were installed as the excitation light source with a 420 nanometers band-pass dichroic mirror and emission filters filtering at 625 nanometers and 800 nanometers. A serial dilution of bovine serum albumin (200 ng-780 pg) was separated on 3 polyacrylamide electrophoresis gels (SDS-PAGE), and respectively blotted to 3 nitrocellulose membranes. Following, an immunodetecion process took place using rabbit anti-BSA. Each membrane was labeled with a) 625 nanometers, b) 800 nanometers fluorescence emitting anti-rabbit quantum dot-conjugated antibody, and c) a control membrane labeled with an HRP conjugated anti-rabbit antibody. The Qdot labeled membranes were exposed in the experimental imager for 2 seconds and the HRP labeled membrane was exposed to film for 60 seconds. Both methods yielded equal detection levels as low as 0.4 ng of BSA. Additional experiments (data not shown) show that imaging the described Qdot labeled membranes with a Fuji LAS-3000 yielded only a 2 fold more sensitive detection at a 2 minute exposure time than to the same membranes imaged in the experimental device at a 2 second exposure time. The membrane shown in FIG. 4 was imaged using the prototype with the set-up described in FIG. 2 and with the 625 nanometers emission filter.

For DNA quantification, a 480 nanometers LED source was used with a 505 nanometers band-pass dichroic minor and an emission filter at 530 nanometers. Serial dilutions of DNA samples were quantified using the Qubit® Fluorometer (HS and BR kits manufactured by Invitrogen, Carlsbad, Calif.), then plated in a 96 well microtiter plate and imaged using the experimental imaging system. The DNA concentrations were calculated by image analysis densitometry. The method allowed batch analysis of multiple samples with accurate results and with a correlation of R̂2=0.982 for samples analyzed by image analysis and an R̂2=0.961 for samples analyzed by Qubit®.

Referring to the results shown in FIG. 4, a serial dilution of bovine serum albumin (200 ng-780 pg) was separated by polyacrylamide gel electrophoresis (PAGE), blotted to a nitrocellulose membrane and detected with rabbit anti-BSA and labeled with 625 nm fluorescence emitting anti-rabbit quantum dot-conjugated antibody. The membrane was imaged using the prototype imaging device with the set-up shown in FIG. 3.

In one embodiment, the modular use of LEDs, dichroic minors and filters in a large scale system which was previously used mainly in microscopy. The modularity of the LED-FILTER and dichroic minor as a unit is also new.

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover modifications and alternate constructions coming within the spirit and scope of the invention as generally expressed by the following claims, which particularly point out and distinctly claim the subject matter of the invention.

1. An apparatus for producing an image of a blotting membrane, comprising:
a housing comprising an enclosure configured to support a blotting membrane comprising an active area including a first fluorescent probe characterized by a first excitation wavelength and a first emission wavelength and a second fluorescent probe characterized by a second excitation wavelength and a second emission wavelength that is different in value from the first emission wavelength;
a light source configured to direct diverging light along a first optical axis and to illuminate an entirety of the active area, the light source comprising a wavelength spectrum that includes the first excitation wavelength and the second excitation wavelength;
an optical system disposed along a second optical axis and configured to form an image of the entirety of the active area, the optical system comprising a lens and an optical filter, the optical filter comprising an optical characteristic that is highly transmissive of light at the first and second emission wavelengths and that is highly reflective or absorptive of light at the first and second excitation wavelengths;
a photodetector configured to receive the image of the entire active area;
a beamsplitter located inside the enclosure and intersecting the first optical axis and the second optical axis;
wherein the beamsplitter comprises an optical characteristic that is either highly transmissive of light at the first and second emission wavelengths and that is highly reflective of light at the first and second excitation wavelengths, or highly transmissive of light at the first and second excitation wavelengths and that is highly reflective of light at the first and second emission wavelengths;

2. The apparatus of claim 1, wherein the first excitation wavelength is equal to the second excitation wavelength.

3. The apparatus of claim 1, wherein the wavelengths are average wavelengths over a band of wavelengths.

4. The apparatus of claim 1, wherein the light source comprises at least two individual light sources characterized by different wavelengths or different wavelength bands.

5. The apparatus of claim 1, wherein the beamsplitter comprises a first face and a second face opposite the first face, the enclosure comprising a first enclosed volume partially bound by the first face and a second enclosed space partially bound by the second face.

6. The apparatus of claim 5, wherein:
the first enclosed space is at least partially bound by the first face of the beamsplitter, a first inner wall of the housing, and a second wall inner wall of the housing;
the second enclosed space is at least partially bound by the second face of the beamsplitter, a third inner wall of the housing, and a fourth wall inner wall of the housing; and
the beamsplitter and at least some of the inner walls block a majority of light at the first excitation wavelength and light at the second excitation wavelength from entering the first enclosed space.

7. The apparatus of claim 6, wherein the beamsplitter comprises a first edge in contact with the one of the inner walls and a second edge opposite the first edge in contact with the one of the inner walls.

8. The apparatus of claim 6, wherein beamsplitter and at least some of the inner walls block at least 95% of light at the first excitation wavelength and light at the second excitation wavelength from entering the first enclosed space.

9. The apparatus of claim 6, wherein the housing comprises the blotting membrane, wherein the photodetector is disposed above the blotting membrane and is configured to receive emission light from the blotting membrane along the second optical axis, the first optical axis being orthogonal to the second optical axis, light from the light source being disposed along an excitation optical path from the light source to the active area that is greater than the distance along an emission optical path from the active area to the lens.

10. The apparatus of claim 6, wherein:
the enclosure comprises a base configured to hold the blotting membrane;
the first inner wall and the third inner wall are side walls disposed on opposite sides of the enclosure, the light source disposed on the third inner wall;
the second inner wall disposed at the top wall of the enclosure, the second inner wall including an aperture above the active area that provides optical communication between the active area and the photodetector;
the fourth inner wall is disposed at the bottom of the enclosure and below the blotting membrane; and
the third inner wall is further from the beamsplitter than the first wall and is further from the beamsplitter than the second wall

11. The apparatus of claim 1, wherein the enclosure comprises a base and the blotting membrane, the blotting membrane disposed on the base.

12. (canceled)

13. The apparatus of claim 11, wherein the blotting membrane comprises a protein immunoblot.

14. The apparatus of claim 11, wherein the blotting membrane comprises a Southern blot.

15. The apparatus of claim 11, wherein the blotting membrane comprises a fluorescent probe material.

16. The apparatus of claim 11, wherein the blotting membrane comprises a nanocrystal probe material.

17. The apparatus of claim 11, wherein the blotting membrane comprises a quantum dot probe material.

18. The apparatus of claim 1, wherein the photodetector comprise a two-dimensional charge coupled device (CCD) detector or a two-dimensional complementary metal-oxide-semiconductor (CMOS) detector.

19. (canceled)

20. A method of imaging of a blotting membrane, comprising:
providing a housing comprising an enclosure configured to support a substrate including a blotting membrane comprising an active area;
placing the substrate within the enclosure;
adding a first fluorescent probe and a second fluorescent probe to the active area, the first fluorescent probe characterized by a first excitation wavelength and a first emission wavelength and the second fluorescent probe characterized by a second excitation wavelength and a second emission wavelength that is different in value from the first emission wavelength;
directing a diverging excitation beam from a light source along a first optical axis and toward the active area, the light source comprising a wavelength spectrum that includes the first excitation wavelength and the second excitation wavelength;
reflecting the beam off a beamsplitter located inside the enclosure and intersecting the first optical axis and the second optical axis;
forming an image of the entirety of the active area using an optical system disposed along a second optical axis, the optical system comprising a lens and an optical emission filter, the optical emission filter comprising an optical characteristic that is highly transmissive of light at the first and second emission wavelengths and that is highly reflective or absorptive of light at the first and second excitation wavelengths;
detecting the entirety of active area image using a photodetector by transmitting emission light through the beamsplitter and through the optical emission filter.

21. A method of imaging of a blotting membrane, comprising:
providing a housing comprising an enclosure configured to support a substrate including a blotting membrane comprising an active area;
placing the substrate within the enclosure;
adding a first fluorescent probe and a second fluorescent probe to the active area, the first fluorescent probe characterized by a first excitation wavelength and a first emission wavelength and the second fluorescent probe characterized by a second excitation wavelength and a second emission wavelength that is different in value from the first emission wavelength;
directing a diverging excitation beam from a light source along a first optical axis and toward the active area, the light source comprising a wavelength spectrum that includes the first excitation wavelength and the second excitation wavelength;
transmitting the beam through a beamsplitter located inside the enclosure and intersecting the first optical axis and the second optical axis;
forming an image of the entirety of the active area using an optical system disposed along a second optical axis, the optical system comprising a lens and an optical emission filter, the optical emission filter comprising an optical characteristic that is highly transmissive of light at the first and second emission wavelengths and that is highly reflective or absorptive of light at the first and second excitation wavelengths;
detecting the entirety of active area image using a photodetector by reflecting emission light off the beamsplitter and transmitting the emission light through the optical emission filter.

22. The apparatus of claim 1, wherein the housing comprises the blotting membrane.
